(19) United States
(12) Patent Application Publication
(10) Pub. No.: US 2014/0081554 A1
(43) Pub. Date: Mar. 20, 2014

(54) Diagnostic device and method for ascertaining an effect of an additive addition on a drive train of a motor vehicle

(71) Applicant: Klaus TREIBER, Neckartenzlingen (DE)

(72) Inventor: Klaus TREIBER, Neckartenzlingen (DE)

(73) Assignee: Robert Bosch GmbH, Stuttgart (DE)

(21) Appl. No.: 14/020,999

(22) Filed: Sep. 9, 2013

(30) Foreign Application Priority Data
Sep. 17, 2012 (DE) 10 2012 216 533.9

(51) Int. Cl. F02D 41/24

(52) U.S. Cl. CPC F02D 41/24
USPC 701/102

(57) ABSTRACT

A diagnostic device for ascertaining an effect of an additive addition on a motor vehicle drive train, having a control device to control an internal combustion engine thereof during the additive addition, based on a control unit parameter(s); a detection device to detect at least one process parameter of the additive addition and at least one operating parameter of the drive train during the additive addition; a comparison device coupled to the detection device to compare the at least one detected process parameter and the at least one detected operating parameter to parameter values stored in a memory device and based thereon to ascertain at least one comparison result; and an evaluation device, coupled to the comparison and control devices, to ascertain the effect of the additive addition on the drive train based on the at least one ascertained comparison result and the at least one control unit parameter.

### RELATED APPLICATION INFORMATION

The present application claims priority to and the benefit of German patent application no. 10 2012 216 533.9, which was filed in Germany on Sep. 17, 2012, the disclosure of which is incorporated herein by reference.

### FIELD OF THE INVENTION

The present invention relates to a diagnostic device and a method for ascertaining an effect of an additive addition on a drive train of a motor vehicle.

### BACKGROUND INFORMATION

U.S. Pat. No. 5,441,072 A discusses a fuel additive injection system which has a detection device for determining an injection flow rate of fuel and for generating a measuring signal as a function of the injection flow rate, a control system for processing the measuring signal, and a metering pump for delivering a fuel additive into the fuel provided for combustion, as a function of the processed measuring signal.

U.S. Pat. No. 4,621,593 A discusses a fuel additive injection system which has electrical control means which, based on an electrical signal, control an operation of an electric pump, and thus achieve a required quantity of the fuel additive in the fuel supply for maintaining a desired uniform concentration.

To eliminate errors that occur in a motor vehicle and to temporarily avoid undesirable running characteristics of an internal combustion engine of the motor vehicle, repair shops use a large product range of additives or other supplements for fuels, and improve the running characteristics of the internal combustion engine by adding additives.

These additive additions allow a distinct improvement in the running characteristics of the internal combustion engine. The use of the additives varies according to the application of the corresponding product. Addition to the fuel tank, addition in a fueling operation, and addition via an oil circuit are possible alternatives in this regard. The success of the additive addition is verified by visual inspection, for example.

### SUMMARY OF THE INVENTION

The exemplary embodiments and/or exemplary methods of the present invention provide a diagnostic device for ascertaining an effect of an additive addition on a drive train of a motor vehicle having the features described herein, and a method for ascertaining an effect of an additive addition on a drive train of a motor vehicle according to the features described herein.

An aspect of the exemplary embodiments and/or exemplary methods of the present invention lies in the fact that the effect of the use of the additive is ascertained by the diagnostic device. In addition, failure of the additive addition may be ascertained by the diagnostic device. By evaluating defined control unit parameters, the repair shop personnel are able to verify product properties of the additive that is added.

Reduced exhaust gas emissions, increased engine power, reduced fuel consumption, or improved smooth running characteristics of the internal combustion engine resulting from use of the additive may advantageously be ascertained using the diagnostic device.

Another advantage of the exemplary embodiments and/or exemplary methods of the present invention is that with regard to the use of an additive product and its success, the repair shop inspecting the motor vehicle is able to ascertain clear, verifiable effects of the additive product on the motor vehicle. This speeds up the decision regarding further troubleshooting during repair of the motor vehicle.

Advantageous specific embodiments and refinements result from the disclosures herein and from the description, with reference to the figures.

According to one specific embodiment of the present invention, it is provided that the detection device is configured to detect a knock sensor signal or a signal regarding a rate of misfires of the internal combustion engine of the motor vehicle as the at least one operating parameter of the drive train. The running characteristics of the internal combustion engine may be advantageously improved in this way.

According to one specific embodiment of the present invention, it is provided that the detection device is configured to detect a coolant temperature of the internal combustion engine or an intake air temperature of the internal combustion engine or a speed of the internal combustion engine or a fuel tank level of the motor vehicle as the at least one operating parameter of the drive train. This advantageously allows the at least one operating parameter of the drive train to be optimized.

According to one specific embodiment of the present invention, it is provided that the detection device is configured to detect an exhaust gas differential pressure of the internal combustion engine or an exhaust gas temperature of the internal combustion engine as the at least one operating parameter of the drive train.

According to one specific embodiment of the present invention, it is provided that the detection device is configured to detect a mixture concentration of the additive addition or a duration of the additive addition as the process parameter of the additive addition. The effects of different process parameters of the additive addition may advantageously be ascertained in this way.

According to one specific embodiment of the present invention, it is provided that the control device is configured to use a lowering of an exhaust gas differential pressure of the internal combustion engine or a lowering of an exhaust gas temperature of the internal combustion engine as the at least one control unit parameter for controlling the internal combustion engine. The ascertainment of the effect of the additive addition may thus advantageously be adapted to the particular type of vehicle.

The described embodiments and refinements may be arbitrarily combined with one another.

Further possible embodiments, refinements, and implementations of the present invention also include combinations, not explicitly mentioned, of features of the present invention described previously, or described below with regard to the exemplary embodiments.

The appended drawings are intended to provide further understanding of the specific embodiments of the present invention. They illustrate specific embodiments, and are used in conjunction with the description to explain principles and concepts of the present invention.

Other specific embodiments and many of the mentioned advantages result with regard to the drawings. The illustrated elements of the drawings are not necessarily shown to scale relative to one another.

### BRIEF DESCRIPTION OF THE DRAWINGS

FIG. 1 shows a schematic illustration of a diagnostic device for ascertaining an effect of an additive addition on a drive train of a motor vehicle according to one specific embodiment of the present invention.

FIG. 2A shows a schematic illustration of characteristic curves of the at least one operating parameter of the drive train of the motor vehicle for explaining the present invention.

FIG. 2B shows a schematic illustration of characteristic curves of the at least one operating parameter of the drive train of the motor vehicle for explaining the present invention.

FIG. 2C shows a schematic illustration of characteristic curves of the at least one operating parameter of the drive train of the motor vehicle for explaining the present invention.

FIG. 3 shows a schematic illustration of a flow chart of a method for ascertaining an effect of an additive addition on a drive train of a motor vehicle according to another specific embodiment of the present invention.

### DETAILED DESCRIPTION

Unless stated otherwise, identical or functionally equivalent elements, parts, components, or method steps are denoted by the same reference numerals in the figures.

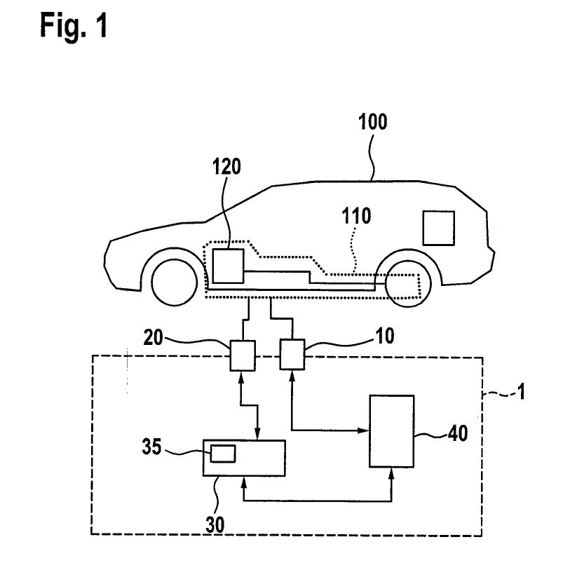

FIG. 1 shows a schematic illustration of a diagnostic device for ascertaining an effect of an additive addition on a drive train of a motor vehicle according to one specific embodiment of the present invention.

A diagnostic device 1 for ascertaining an effect of an additive addition on a drive train 110 of a motor vehicle 100 includes, for example, a control device 10, a detection device 20, a comparison device 30, and an evaluation device 40.

Control device 10 is coupled to drive train 110 of the motor vehicle 100, for example, and is configured to control an internal combustion engine 120 of drive train 110 during the additive addition, based on at least one control unit parameter.

Detection device 20 is coupled to drive train 110 of motor vehicle 100, for example, and is configured to detect at least one process parameter of the additive addition and at least one operating parameter of drive train 110 of motor vehicle 100 during the additive addition.

Control device 10 and detection device 20 may be coupled via a standard interface, such as an on-board diagnostic system (OBD for short). An on-board diagnostic system is a vehicle diagnostic system. During the driving operation, all systems of motor vehicle 100 which influence the exhaust gas are monitored, as well as other important control units whose data are available via the control unit software.

For example, detection device 20 may also be configured to be coupled to a sensor system integrated into motor vehicle 100, and to detect a viscosity of motor oil present in internal combustion engine 120 via the sensor system which is integrated into motor vehicle 100.

Comparison device 30 is coupled to detection device 20, and is configured to compare the at least one detected process parameter and the at least one detected operating parameter to parameter values stored in a memory device 35 and, based on same, to ascertain at least one comparison result.

Evaluation device 40 is coupled to comparison device 30 and control device 10, for example, and is configured to ascertain the effect of the additive addition on drive train 110 of motor vehicle 100 based on the at least one ascertained comparison result and the at least one control unit parameter.

Depending on the customer complaint, different additives may be used as the additive addition in the repair shop. For problems with the diesel particle filter, for example, a diesel particle filter cleaner may be used, and for improving the knock properties, for example, an octane booster may be used as an additive. For reducing the exhaust gas emissions, a fuel system cleaner and/or an additional fuel lubricant additive may be used. Depending on the application, different control unit parameters may be used for verifying the effect of diagnostic device 1.

For an additive use of an octane booster, under defined engine conditions such as coolant temperature, intake air temperature, engine speed, or fuel tank level, diagnostic device 1 ascertains the following parameters, for example: knock sensor signal, engine misfires, or smooth running values of the cylinders of internal combustion engine 120.

The operating parameters are evaluated after the additive is added. For example, the knock sensor signal drops after addition of the additive. Likewise, the differences in the smooth running values of the individual cylinders may level out. By comparing the detected operating parameter values to the parameter values stored in memory device 35, it may be ascertained whether or not the additive use was successful.

For an additive use of a diesel particle filter cleaner, under defined engine conditions, diagnostic device 1 ascertains, for example, an exhaust gas differential pressure and an exhaust gas temperature as the at least one operating parameter of drive train 110 of motor vehicle 100.

For an additive use of a fuel system cleaner, under defined engine conditions, diagnostic device 1 ascertains, for example, a short-term mixture correction value, a lambda adaptation value, or some other lambda value as the at least one operating parameter of drive train 110 of motor vehicle 100.

Control device 10, detection device 20, comparison device 30, and evaluation device 40 are configured, for example, as a processor unit or some other electronic data processing unit. Control device 10, detection device 20, comparison device 30, and evaluation device 40 are also configured, for example, as a microcontroller, also referred to as a p-controller, which in addition to a processor combines units for peripheral functions on a chip.

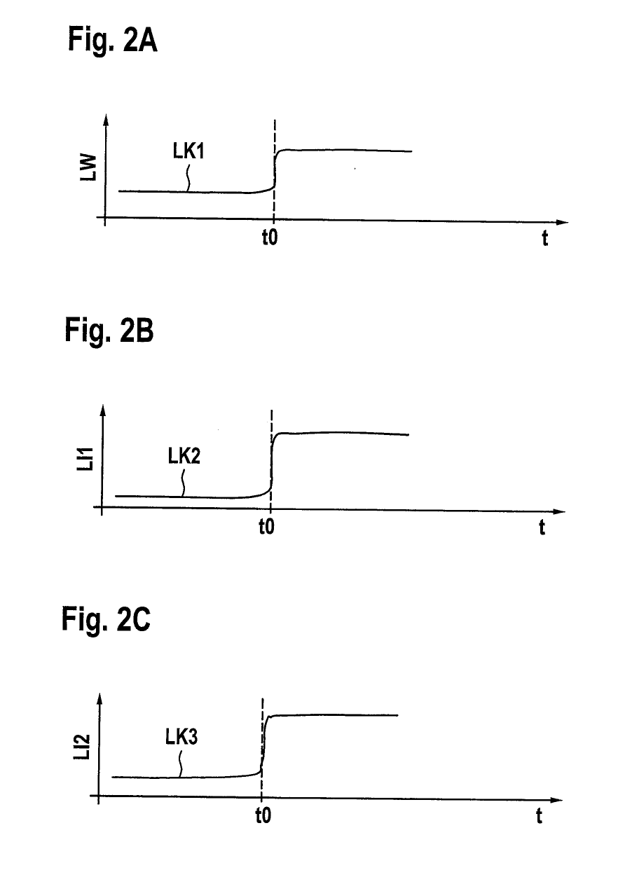

FIGS. 2A, 2B, and 2C each show a schematic illustration of characteristic curves of the at least one operating parameter of drive train 110 of motor vehicle 100 for explaining the present invention.

FIG. 2A shows a schematic illustration of a diagram having a function graph for the time dependency of the lambda value of drive train 110 of motor vehicle 100.

Time t is plotted on the x axis of the diagram illustrated in FIG. 2A, and the y axis represents lambda value LW of drive train 110.

Characteristic curve LK1 represents the change over time of lambda value LW of drive train 110. Characteristic curve LK1 has a steep, step-like rise at point in time t0. Before and after point in time t0, characteristic curve LK1 is characterized by an approximately horizontally extending plateau area.

FIG. 2B shows a schematic illustration of a diagram having a function graph for the time dependency of a function value of a lambda value integrator.

Time is plotted on the x axis of the diagram illustrated in FIG. 2B, and the y axis represents the function value of a first lambda value integrator LI1.

Characteristic curve LK2 represents the change over time of the function value of first lambda value integrator LI1.

Characteristic curve LK2 has a steep, step-like rise at point in time t0. Before and after point in time t0, characteristic curve LK2 is characterized by an approximately horizontally extending plateau area.

For example, first lambda value integrator LI1 is detected by detection device 20 as the at least one operating parameter, and is compared by comparison device 30 to parameter values stored in a memory device 35.

FIG. 2C shows a schematic illustration of a diagram having a function graph for the time dependency of a function value of a lambda value integrator.

Time t is plotted on the x axis of the diagram illustrated in FIG. 2C, and the y axis represents the function value of a second lambda value integrator LI2.

Characteristic curve LK3 represents the change over time of the function value of second lambda value integrator LI2. Characteristic curve LK3 has a steep, step-like rise at point in time t0. Before and after point in time t0, characteristic curve LK3 is characterized by an approximately horizontally extending plateau area.

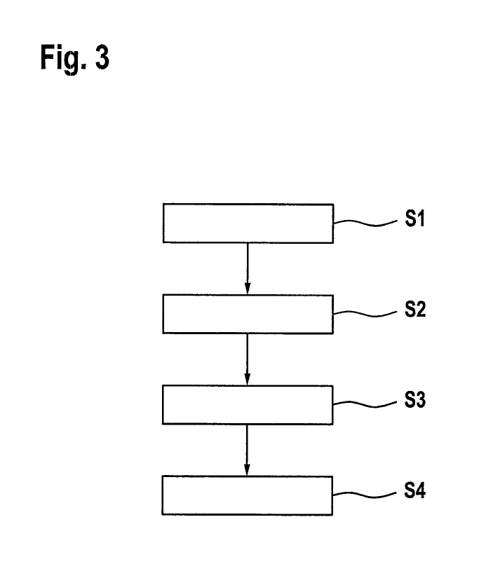

FIG. 3 shows a schematic illustration of a flow chart of a method for ascertaining an effect of an additive addition on a drive train of a motor vehicle according to another specific embodiment of the present invention.

A control S1 of drive train 110 of motor vehicle 100 based on at least one control unit parameter is carried out by a control device 10 as a first method step.

A detection S2 of at least one process parameter of the additive addition and of at least one operating parameter of drive train 110 of motor vehicle 100 is carried out by a detection device 20 during the additive addition, as a second method step.

For example, a knock sensor signal or a signal regarding a rate of misfires of internal combustion engine 120 of motor vehicle 100 or a signal regarding a rate of a smooth running value of a cylinder of internal combustion engine 120 of motor vehicle 100 is detected as the at least one operating parameter of drive train 110 of motor vehicle 100.

In addition, a coolant temperature of internal combustion engine 120 or an intake air temperature of internal combustion engine 120 or a speed of internal combustion engine 120 or a fuel tank level of motor vehicle 100 may be detected as the at least one operating parameter of drive train 110.

A comparison S3 of the at least one detected process parameter and the at least one detected operating parameter with parameter values stored in a memory device 35, by a comparison device 30, and ascertainment of at least one comparison result based on same are carried out as a third method step.

An ascertainment S4 of the effect of the additive addition on drive train 110 of motor vehicle 100 based on the at least one comparison result and based on the at least one control unit parameter is carried out by an evaluation device 40 as a fourth method step.

The method steps may be repeated iteratively or recursively in any arbitrary sequence.

Although the exemplary embodiments and/or exemplary methods of the present invention have been described above with reference to the exemplary embodiments, it is not limited thereto, and may be modified in numerous ways. In particular, the exemplary embodiments and/or exemplary methods of the present invention may be changed or modified in various ways without departing from the core of the exemplary embodiments and/or exemplary methods of the present invention.

What is claimed is:

1. A diagnostic device for ascertaining an effect of an additive addition on a drive train of a motor vehicle, comprising:
a control device to control an internal combustion engine of the drive train during the additive addition, based on at least one control unit parameter;
a detection device to detect at least one process parameter of the additive addition and at least one operating parameter of the drive train during the additive addition;
a comparison device coupled to the detection device and which is configured to compare the at least one detected process parameter and the at least one detected operating parameter to parameter values stored in a memory device and, based on same, to ascertain at least one comparison result; and
an evaluation device coupled to the comparison device and the control device, and which is configured to ascertain the effect of the additive addition on the drive train of the motor vehicle based on the at least one ascertained comparison result and the at least one control unit parameter.

2. The diagnostic device of claim 1, wherein the detection device is configured to detect a knock sensor signal or a signal regarding a rate of misfires of the internal combustion engine of the motor vehicle or a signal regarding a rate of a smooth running value of a cylinder of the internal combustion engine of the motor vehicle as the at least one operating parameter of the drive train of the motor vehicle.

3. The diagnostic device of claim 1, wherein the detection device is configured to detect a coolant temperature of the internal combustion engine or an intake air temperature of the internal combustion engine or a speed of the internal combustion engine or a fuel tank level of the motor vehicle as the at least one operating parameter of the drive train of the motor vehicle.

4. The diagnostic device of claim 1, wherein the detection device is configured to detect an exhaust gas differential pressure of the internal combustion engine or an exhaust gas temperature of the internal combustion engine as the at least one operating parameter of the drive train of the motor vehicle.

5. The diagnostic device of claim 1, wherein the detection device is configured to detect a mixture concentration of the additive addition or a duration of the additive addition as the process parameter of the additive addition.

6. The diagnostic device of claim 1, wherein the control device is configured to use a lowering of an exhaust gas differential pressure of the internal combustion engine or a lowering of an exhaust gas temperature of the internal combustion engine as the at least one control unit parameter for controlling the internal combustion engine.

7. A method for ascertaining an effect of an additive addition on a drive train of a motor vehicle, the method comprising:
controlling the drive train of the motor vehicle by a control device, based on at least one control unit parameter;
detecting at least one process parameter of the additive addition and at least one operating parameter of the drive train of the motor vehicle by a detection device during the additive addition;
comparing the at least one detected process parameter and the at least one detected operating parameter to parameter values stored in a memory device, by a comparison device, and ascertaining at least one comparison result based on same; and
ascertaining the effect of the additive addition on the drive train of the motor vehicle based on the at least one comparison result and based on the at least one control unit parameter, by an evaluation device.

8. The method of claim 7, wherein a knock sensor signal or a signal regarding a rate of misfires of the internal combustion engine of the motor vehicle or a signal regarding a rate of a smooth running value of a cylinder of the internal combustion engine of the motor vehicle is detected as the at least one operating parameter of the drive train of the motor vehicle.

9. The method of claim 7, wherein a coolant temperature of the internal combustion engine or an intake air temperature of the internal combustion engine or a speed of the internal combustion engine or a fuel tank level of the motor vehicle is detected as the at least one operating parameter of the drive train of the motor vehicle.

10. The method of claim 7, wherein an exhaust gas differential pressure of the internal combustion engine or an exhaust gas temperature of the internal combustion engine is detected as the at least one operating parameter of the drive train of the motor vehicle.

11. The method of claim 7, wherein a mixture concentration of the additive addition or a duration of the additive addition is detected as the at least one process parameter of the additive addition.

12. The method of claim 7, wherein a lowering of an exhaust gas differential pressure of the internal combustion engine or a lowering of an exhaust gas temperature of the internal combustion engine is used as the at least one control unit parameter for controlling the internal combustion engine.
